(19) United States
(12) Patent Application Publication
(10) Pub. No.: US 2018/0003145 A1
(43) Pub. Date: Jan. 4, 2018

(54) FREELY-CONTROLLED POWER GENERATION APPARATUS

(71) Applicant: SEO JUN LTD., Gangneung-si, Gangwon-do (KR)

(72) Inventor: Minsi JEONG, Gangneung-si (KR)

(73) Assignee: SEO JUN LTD., Gangneung-si, Gangwon-do (KR)

(21) Appl. No.: 15/540,989

(22) PCT Filed: Oct. 23, 2015
(86) PCT No.: PCT/KR2015/011248

§ 371 Date: Jun. 29, 2017

(30) Foreign Application Priority Data
Apr. 20, 2015 (KR) 10-2015-0055030
Apr. 23, 2015 (KR) 10-2015-0056909
May 22, 2015 (KR) 10-2015-0071901

(51) Int. Cl. F03B 13/10; F03B 3/12; F03B 3/04; F03B 15/04; F03B 15/14

(52) U.S. Cl. CPC F03B 13/10; F03B 3/12; F03B 3/04; F03B 15/14; F03B 15/04

(57) ABSTRACT

The present invention relates to a power generation apparatus and, more specifically, to a freely-controlled power generation apparatus configured so as to generate electric power while being freely controlled under optimal conditions, since a cylinder body for supporting screws submerged under water is elevated by buoyancy or rotated according to the flow of the water.

### TECHNICAL FIELD

The present invention relates to a power generation apparatus and, more particularly, to a freely controlled power generation apparatus configured so as to generate electric power while being freely controlled under optimal conditions, since a cylindrical body for supporting screws submerged under water is elevated by buoyancy or rotated according to the flow of the water.

### BACKGROUND ART

In general, the generation of hydroelectric power uses the potential energy of water. In the generation of hydroelectric power, a turbine installed on a dam is required to use the potential energy of water. When water falls on the turbine, the potential energy of water is converted into kinetic energy that rotates the turbine in accordance with the kinetic energy conservation law. In other words, water is confined in the upstream of the dam and the gate of the dam is open, so the water drops to the downstream of the dam to rotate the turbine. In this process, the potential energy of the water is converted into the kinetic energy of the turbine, and the head of the dam is required to use the potential energy of the water. As a rotor coil within the turbine rotates along with the turbine, an electromagnetic induction phenomenon is generated and thus current is generated. The kinetic energy of the turbine is converted into electrical energy through the process. Meanwhile, the generation of small hydraulic power is a method of generating electricity by installing a small turbine on a dam of a relatively small reservoir or the reservoir of a river.

In the generation of common hydroelectric power, such as that described above, there is a problem that hydroelectric power generation cannot be efficiently performed if the size of a dam is not large or flow velocity is not high. In particular, if the water level of the dam is lowered during the dry season, a head necessary for power generation is not sufficient and hydroelectric power generation cannot be performed because water cannot flow down to the downstream due to the lack of a water capacity.

Meanwhile, in the case of Korea, there are abundant hydroelectric energy, such as a large amount of water flow attributable to the difference between the rise and fall of the tide in the west coast and a seawater flow between islands in the south coast, but the abundant hydroelectric energy is not properly used. Accordingly, if there is an apparatus that may be used for power generation even at a slow rate, green energy can be used. That is, the economic burden of an installation cost can be solved if a natural low-speed flow rate can be used for power generation instead of a method of using a high-speed flow rate using a head after the confinement of water at a high economic cost.

### PRIOR ART DOCUMENT

(Patent Document 0001) KR20120008204 A1

(Patent Document 0002) KR1185642 B1

(Patent Document 0003) KR1504866 B1

(Patent Document 0004) KR1510633 B1

(Patent Document 0005) WO 2008/065684

(Patent Document 0006) EP 02613046

(Patent Document 0007 JP200936113

(Patent Document 0008) WO14198965A1

### SUMMARY OF THE INVENTION

Accordingly, the present disclosure provides a freely controlled power generation apparatus according to an exemplary embodiment of the present invention that capable of reducing an economic cost according to the development and production of renewable energy by enabling small hydraulic power generation at a lower cost while utilizing the existing structure for multiple purposes in such a way as to enable small hydraulic power generation relatively simply using the existing structure.

In addition, according to an exemplary embodiment of the present disclosure provides a freely controlled power generation apparatus, which can generate electrical power using the flow of water under water and in which a screw provided in the power generation apparatus can be optimized in response to a change in the direction of the flow of water and a change in the depth of water and efficiency of power generation can be maximized although the flow of water and the depth of water are changed.

In addition, according to an embodiment of the present disclosure provides a non-shaft screw power generation apparatus which generates power using water that flows in a deep river or sea and to provide a non-shaft screw power generation apparatus which enables large-sized power generation using the difference between the rise and fall of the tide in the west coast and a seawater flow occurring in the topography in the south coast.

Meanwhile, according to a freely controlled power generation apparatus are not limited above mentioned, and other are not mentioned in the following description, the present invention have been shown and described, simply by way of illustration.

A freely controlled power generation apparatus may further include a support assembled and disposed on the outer circumferential surface of a vertical structure by a waterwheel fixing block, having first supports integrally extended and installed on the support horizontally based on the waterwheel fixing block on both left and right sides thereof, and supporting and fixing at least one waterwheel to be spaced apart at a specific interval by the first supports and second supports having at least one auxiliary support corresponding to the first supports formed therein, wherein the support supports and fixes the waterwheels to be immersed under the surface of water so that the waterwheels are freely rotatable depending on the amount of water and a flow rate around the vertical structure; the at least one waterwheel having a waterwheel blade of a screw shape formed on the external surface of a rotating shaft of a rod shape, wherein both ends of the rotating shaft are supported by the support in such a way as to be freely rotatable, and performing a rotational motion on the rotating shaft by the rotatory power of the waterwheel blade attributable to a flow of water; and a power generation member connected through a power transmission member including a plurality of gears connected to one end of the rotating shaft and generating electrical energy by a rotational motion of the rotating shaft, wherein the freely controlled power generation apparatus further includes a waterwheel movement guide member including a guide block having one end assembled and fixed to the waterwheel fixing block in parallel to the waterwheel and the other end formed to be movable up and down and left and right as a free end, wherein the body of the free end is extended and installed up and down and an up/down guide groove into which the second support is able to be fit and assembled is formed at the extended and installed end, and the waterwheel movement guide member limitedly guides and supports the up/down movement and left/right movement of the waterwheel according to the amount of water and the flow rate within a specific range.

The present disclosure provides a freely controlled power generation apparatus may include the second support may have a left/right guide rod fit and assembled into the up/down guide groove of the guide block and integrally provided at the central part, and hitch jaws for limiting a left/right movement within a specific range may be formed on both sides of the left/right guide rod.

In addition, the present disclosure provides a freely controlled power generation apparatus may include the support may be arranged in two columns or more in parallel up and down and assembled and disposed on the outer circumferential surface of the vertical structure by each waterwheel fixing block, and at least one waterwheel may be installed on each of the supports.

the present disclosure provides a freely controlled power generation apparatus may include a vertical structure immersed in water; a cylindrical body disposed on the outer circumferential surface of the vertical structure in such a way as to elevate and rotate; a buoyant body fixed with respect to the cylindrical body and providing buoyancy; a plurality of support extended from the cylindrical body; at least one waterwheel having a waterwheel blade of a screw shape formed on the external surface of a rotating shaft of a rod shape, wherein both ends of the rotating shaft are supported by the support in such a way as to be freely rotatable, and performing a rotational motion on a waterwheel shaft by the rotatory power of the waterwheel blade attributable to a flow of water; a power transmission member transferring the rotatory power of the waterwheel; a power generation member generating electricity by electric power transferred through the power transmission member; and a bearing assembly including a bearing plate surrounding the vertical structure and a plurality of balls rotatably buried in the bearing plate, wherein the bearing assembly is disposed between an outer surface of the vertical structure and an inner surface of the cylindrical body.

In addition, the present disclosure provides a freely controlled power generation apparatus may further include an upper hitch jaw and a lower hitch jaw are having in the vertical structure in order to restrict the elevation of the cylindrical body.

Furthermore, the present disclosure provides a freely controlled power generation apparatus may further include a bearing assembly are having an annular plate and a plurality of balls rotatably buried in an inner circumferential surface of the annular plate, wherein the bearing assembly may be disposed at each of the upper and lower parts of the cylindrical body.

In addition, the present disclosure provides a freely controlled power generation apparatus may further include the cylindrical body are having a first half cylindrical portion and a second half cylindrical portion, and the first half cylindrical portion and the second half cylindrical portion may be interconnected by a connection plate.

Furthermore, various aspects of the present invention are directed to providing a freely controlled power generation apparatus may include the power transmission member are having a first driven shaft extended in parallel to the support supporting the rotating shaft of the waterwheel; a second driven shaft extended in parallel to the vertical structure; and gears disposed in the rotating shaft of the waterwheel, the first driven shaft and the second driven shaft and engaged with each other.

The present disclosure provides a freely controlled power generation apparatus may include, at least any one of the supports extended from the cylindrical body are having a fixing support and an insertion support capable of being inserted into the hollow portion of the fixing support.

Furthermore, the present disclosure provides a freely controlled power generation apparatus may include the waterwheel are configured a non-shaft screw, and the non-shaft screw are having a rotary blade of a screw shape and a first support unit and second support unit respectively extended from a first end and second end in accordance with the center of rotation of the non-shaft screw.

Furthermore, the present disclosure provides a freely controlled power generation apparatus may include a sheet-shaped member are having a specific thickness and a gradually increasing width in the rotary blade of the non-shaft screw may be configured to have a screw shape, and the diameter of the rotary blade may increase from the first support unit to the second support unit.

In addition, the present disclosure provides a freely controlled power generation apparatus may include each of two sheet-shaped members are having a specific thickness and a gradually increasing width in the rotary blade of the non-shaft screw may be configured to have a screw shape in the state in which the two sheet-shaped members have been disposed at a right angle to each other at one end, and the diameter of the rotary blade may increase from the first support unit to the second support unit.

Furthermore, the present disclosure provides a freely controlled power generation apparatus may include a diameter of the rotary blade at the first end of the non-shaft screw may be smaller than the diameter of the rotary blade at the second end, and the first end of the non-shaft screw may face the upstream side of a flow of a fluid. In addition, the present disclosure provides a freely controlled power generation apparatus may include each of two sheet-shaped members having a specific thickness in the rotary blade of the non-shaft screw may be configured to have a screw shape in the state in which the two sheet-shaped members have been disposed at a right angle to each other at one end, and the diameter of the rotary blade may be the same in the first support unit and the second support unit.

A freely controlled power generation apparatus according to the exemplary embodiment of the present invention can be obtained an advantage of reducing the economic cost according to the development and production of renewable energy by enabling small hydraulic power generation at a lower cost while utilizing the existing structure for multiple purposes in such a way as to enable small hydraulic power generation relatively simply using the existing structure.

In addition, a freely controlled power generation apparatus according to the exemplary embodiment of the present invention, the efficiency of power generation can be maximized because there is no influence attributable to a change in the direction of the flow of water and a change in the direction of the flow of water can be handled. In addition, there is an effect in that the screw of the power generation apparatus can generate power in an optimal depth because the power generation apparatus can be elevated by the buoyant body although the depth of water is changed.

In addition, a freely controlled power generation apparatus according to the exemplary embodiment of the present invention, the elevation height of the screw according to buoyancy can be determined by taking into consideration surrounding underwater environments, a plurality of the screws can be vertically disposed, and a plurality of the screws can also be horizontally installed. In addition, there are advantages in that stability can be secured and the direction of the flow of water can be rapidly handled by minimizing a force applied to an element in such a way as to harmonize the weight of each of elements forming the power generation apparatus with the buoyant body.

Furthermore, a freely controlled power generation apparatus according to the exemplary embodiment of the present invention, the non-shaft screw power generation apparatus is a method of generating power using the flow rate of water that flows in a deep river or sea, and can generate power using the flow rate of water generated due to the difference between the rise and fall of the tide as in the west coast and a flow rate generated due to the topographical influence of islands in the south coast. The non-shaft screw power generation apparatus according to the present invention has advantages in that it enables large-sized power generation because forces of a wide range of flow rates are used and it is economical due to a low installation cost because the power generation apparatus does not require a civil engineering structure for using a head and can use even a slow flow rate for power generation.

Meanwhile, according to a freely controlled power generation apparatus are not limited above mentioned efficiency, and other are not mentioned efficiency in the following description, the present invention have been shown and described, simply by way of illustration.

### BRIEF DESCRIPTION OF THE DRAWINGS

The following accompanied drawings attached to the description illustrates one preferred exemplary embodiment of the present invention and function to facilitate further understanding of the technological spirit of the present invention along with the detailed description of the invention. Accordingly, the present invention should not be construed as being limited to only contents illustrated in the drawings.

FIG. 1 is a perspective view of a freely controlled power generation apparatus according to the first exemplary embodiment of the present invention,

FIG. 2 is a perspective view of a freely controlled power generation apparatus according to the second exemplary embodiment of the present invention,

FIG. 3 is an exploded perspective view of part of a freely controlled power generation apparatus according to the third exemplary embodiment of the present invention,

FIGS. 4 and 5 are schematic perspective views of examples of non-shaft screws to which the freely controlled power generation apparatus according to the present invention may be applied,

FIGS. 6 and 7 are schematic perspective views of other examples of non-shaft screws to which the freely controlled power generation apparatus according to the present invention may be applied.

### DESCRIPTION OF SYMBOLS

11: floor structure 12: vertical structure 13: cylindrical body

13a: first half cylindrical portion 13b: second half cylindrical portion

14: support 14a: first support 14a-1: fixing support

14a-2: insertion support 14b: second support 14c: third support

14d: second support 14e: waterwheel fixing block

14f: left and right support bar 15: connection plate

15a: through hole 15b: bolt for connection plate

16a: upper hitch jaw 16b: lower hitch jaw

17: bearing assembly 17a: ball

30: upper bearing assembly 32: upper annular plate

32a: hole 32b: bolt

42a: upper bearing seating unit 42b: lower bearing seating unit

43: screw hole

50: power transmission member 51: first driving gear 52: first driven gear

53: first driven shaft 54: first driven shaft fixing member 55: second driving gear

60: waterwheel 61: rotating shaft 62: waterwheel blade

63: driving gear connection part 70: power generation member 71: second driven shaft

72: second driven shaft fixture 73: second driven gear

80: waterwheel movement guide member 81: guide block support 82: guide block

83: up/down guide groove

90: non-shaft screw 91: rotary blade 91a: first rotary blade

91b: second rotary blade 92: first support unit 93: second support unit

100: freely controlled power generation apparatus B: buoyant body G: generator.

### Best Mode for Embodiments

The present disclosure and advantages of accomplishing the same may be understood more readily by reference to the following detailed description of preferred exemplary embodiments and the accompanying drawings. However, the present disclosure may be embodied in many different forms, and should not be construed as being limited to the embodiments set forth herein. On the contrary, exemplary embodiments introduced herein are provided to make the disclosed contents thorough and complete and to sufficiently trasnfer the spirit of the present invention to those skilled in the art.

Terms used in this description are illustrating the exemplary embodiments and are not limited to the present invention. In this description, the singular form, unless specially described otherwise in the context, may include the plural form. ‘Comprises’ and/or ‘comprising’ used in the specification do not exclude the existence or addition of one or more elements in a described element.

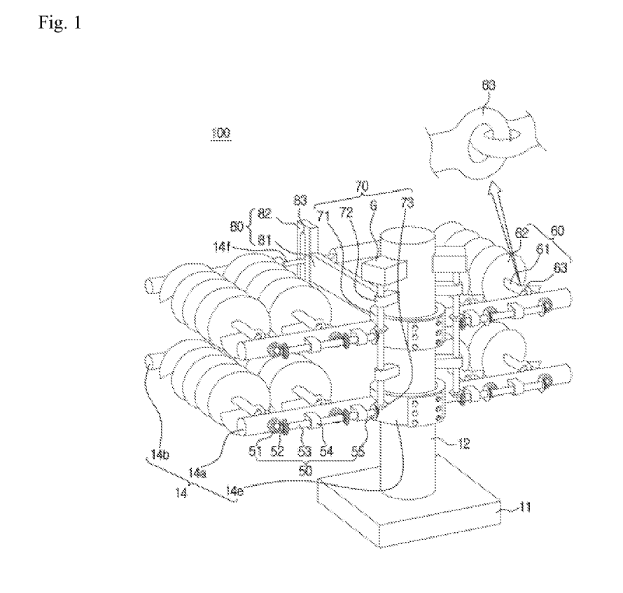

FIG. 1 is a perspective view illustrating the configuration of major elements of a freely controlled power generation apparatus 100 according to the first exemplary embodiment of the present invention. As illustrated in the drawing, the freely controlled power generation apparatus 100 according to the present invention may be implemented as a first embodiment to include a support 14, at least one waterwheel 60, and a power generation member 70 and may be implemented as another embodiment may further include a waterwheel movement guide member 80.

In the following detailed description, the substructure of a bridge, for example, may be adopted as a floor substructure. That is, a configuration installed on a vertical structure 12, that is, a long column type or cylindrical pier pillar which supports a bridge girder and transfers weight from the bridge girder to a lower ground through a base, is described in detail as a representative example. However, the present invention may be installed using various not-illustrated methods.

The support 14 may be configured to include a waterwheel fixing block 14e, a first support 14a, a second support 14b, and a power transmission member 50.

The support 14 has the waterwheel fixing block 14e of a shape corresponding to the vertical structure 12 at its central part. The support 14 is assembled and disposed in the lower part of the vertical structure 12 through separate assembly means by the waterwheel fixing block 14e. Furthermore, the support 14 has the first supports 14a horizontally integrally extended and installed on the basis of the waterwheel fixing block 14e on both left and right sides thereof, respectively. The support 14 supports and fixes the at least one waterwheel 60 at a specific interval by the first support 14a and the second support 14b having at least one auxiliary support formed therein in accordance with the first support 14a. The support 14 supports and fixes the at least one waterwheel 60 in such a manner that they are immersed in water so that they are freely rotated depending on the amount of water and a flow rate around the vertical structure 12.

In addition, the support 14 may be arranged in parallel at the lower part of the vertical structure 12 in two columns or more up and down by the respective waterwheel fixing blocks 14e and assembled and disposed. In this case, at least one waterwheel 60 or two waterwheels or more may be arranged in parallel in each support 14.

The second support 14b has a left/right guide rod 14f integrally assembled at its central part so that the second support 14b is fit and assembled into the up/down guide groove 83 of a guide block 82 and a hitch jaw for limiting a left/right movement within a specific range is formed on both sides thereof. In this case, the left/right guide rod 14f may be fit and assembled into the central part of the second support 14b using separate assembly means. If the waterwheel fixing block 14e are arranged in parallel in two columns or more up and down and assembled as described above, the number of second support 14b corresponding to the number of waterwheel fixing block 14e may be provided. In this case, a middle holder that connects two upper and lower holders may be further included.

The first support 14a are horizontally extended and installed on the basis of the waterwheel fixing block 14e on both left and right sides thereof. At least one through hole capable of rotatably assembling one end of a waterwheel shaft is formed in the first support 14a. One end of a rotating shaft 61 is assembled and disposed in the through hole by a driving gear connection part 63 in such a way as to freely rotate. The power transmission member 50 is assembled into the first support 14a through the driving gear connection part 63. Accordingly, the first support 14a is configured to transfer the rotational motion of the rotating shaft 61 to the power generation member 70.

The power transmission member 50 changes the direction of the rotational motion of the rotating shaft 61 at least once and transfers the rotational motion to the power generation member 70. The power transmission member 50 is integrally disposed in the first support 14a of the support 14. To this end, the power transmission member 50 may be preferably configured to include a first driving gear 51, a first driven gear 52, a first driven shaft 53, a first driven shaft fixture 54, and a second driving gear 55. Furthermore, in order to minimize a frictional force attributable to the rotation of the first driven shaft 53, bearings may be disposed within the first driven shaft fixture 54.

The first driving gear 51 is directly coupled to the driving gear connection part 63 of the waterwheel 60 assembled into the first support 14a to be freely rotated and is integrally rotated with the rotating shaft 61.

The first driven gear 52 is disposed to be engaged with the first driving gear 51 and disposed in the first driven shaft 53 in such a way as to be integrally rotated with the first driven shaft 53.

The first driven shaft 53 is assembled into the first support 14a to be perpendicular to the rotating shaft 61, but is supported and fixed by the first driven shaft fixture 54 to be integrally rotated with the first driven gear 52 and is disposed in the first support 14a.

The first driven shaft fixture 54 fixes the first driven shaft 53 to the first support 14a so that the first driven shaft 53 is rotatable.

The second driving gear 55 changes the direction of the rotatory power of the first driven shaft 53 and transfers the rotatory power to the second driven gear 73 of the second driven shaft 71 of the power generation member 70.

The waterwheel 60 has a waterwheel blade 62 of a screw (S) shape formed on the outer surface of the rotating shaft 61 of a rod shape and has both ends of the rotating shaft 61 supported by the support 14 in such a way as to be freely rotatable. Accordingly, the waterwheel 60 performs a rotational motion on the rotating shaft 61 by the rotatory power of the waterwheel blade 62 according to the flow of water. In this case, it is preferred that the waterwheel blade 62 of a screw (S) shape is formed to have specific gravity similar to that of water in order to minimize weight and to less experience the resistance of a flow rate. The waterwheel 60 may be disposed in pairs with respect to each of the first support 14a. The driving gear connection part 63 integrally rotated with the rotating shaft 61 is provided at one end of the waterwheel 60, so the waterwheel 60 is connected to the power transmission member 50 through the driving gear connection part 63. Of course, the waterwheel 60 may be configured so that the rotating shaft is inserted and protruded into the through hole of the first support 14a without the driving gear connection part 63 and the first driving gear 51 is disposed at the end of the rotating shaft.

The power generation member 70 may includes a generator G. The power generation member 70 is connected to one end of the rotating shaft 61 through the second driven shaft 71 and at least one gear, and it receives the rotational kinetic energy of the rotating shaft 61 and generates electrical energy by converting the rotational kinetic energy. To this end, the power generation member 70 may be configured to include the generator G, the second driven shaft 71, the second driven shaft fixture 72, and the second driven gear 73. Furthermore, bearings may be disposed within the second driven shaft fixture 72 in order to minimize a frictional force attributable to the rotation of the second driven shaft 71.

The generator G is disposed at the upper end of the vertical structure 12 so that it is not immersed in water, and it is connected to the second driven shaft 71 to generate electrical energy using its rotatory power.

The second driven shaft 71 is supported and fixed by the second driven shaft fixture 72 in such a way as to be integrally rotated with the second driven gear 73 and is disposed in the vertical structure 12.

The second driven shaft fixture 72 fixes the second driven shaft 71 to the vertical structure 12 so that the second driven shaft 71 is rotatable.

The second driven gear 73 is disposed to be engaged with the second driving gear 55 of the power transmission member 50 and is disposed to be integrally rotated with the second driven shaft 71.

The waterwheel movement guide member 80 is formed of a guide block support 81 and a guide block 82. The guide block support 81 has one end assembled and fixed to the waterwheel fixing block 14e in parallel to the waterwheel 60 and has the other end formed as a free end in such a way as to move up and down and left and right. The body of the free end is extended and installed up and down. The up/down guide groove 83 capable of fitting and assembling the second support 14b of the support 14 into the extended and installed end is formed in the guide block 82. Accordingly, the waterwheel movement guide member 80 limitedly guides and supports the up/down movement and left/right movement of the waterwheel 60 according to the amount of water and a flow rate within a specific range.

The waterwheel movement guide member 80 is disposed to apply adaptability to the waterwheel blade 62 in response to a change in the direction of the flow of a flow rate or to prevent the screw type waterwheel blade 62 from coming into contact with a structure, such as a pier pillar. The waterwheel movement guide member 80 may be omitted, if necessary, and may be configured in a fixed type. In this case, the waterwheel movement guide member 80 may be optionally applied by taking into consideration the size and shape of the screw type waterwheel blade, the amount of power generated, the safety and influence of a structural beam, a flow rate and so on.

A detailed operation of the freely controlled power generation apparatus 100 configured as described above according to the present invention and acting effects thereof are as follows.

First, one end of the guide block support 81 of the waterwheel movement guide member 80 is assembled to be supported by the waterwheel fixing block 14e, provided at the central part of the support 14, using separate assembly means, but is assembled so that the up/down guide groove 83 of the guide block 82 is perpendicularly erect.

Next, the left/right guide rods 14f are inserted into the up/down guide groove 83 of the guide block 82 formed in the other end of the guide block support 81 assembled as described above in such a way as to be intersected, and the second support 14b are assembled on both sides of the left/right guide rod 14f using separate assembly means. Accordingly, the left/right guide rod 14f at the center of the second support 14b can move up and down along the up/down guide groove 83 of the guide block 82. The guide block 82 is disposed to move left and right along the left/right guide rod 14f at the center of the second support 14b. Such a movement is restricted within a specific range by the second support 14b that functions as a hitch jaw in the periphery of the left/right guide rod 14f and the body of the guide block 82 that functions as a hitch jaw in the periphery of the up/down guide groove 83.

Subsequently, the waterwheel 60 are spaced apart at a specific interval and supported and fixed by the first support 14a horizontally integrally extended and installed on the basis of the waterwheel fixing block 14e on both left and right sides thereof and the second support 14b corresponding to the first support 14a. One end of each of the rotating shaft 61 is connected to the driving gear connection part 63. In this case, the driving gear connection part 63 for being connected to one end of the rotating shaft 61 is provided in the first support 14a in accordance with the number of waterwheel shaft. The driving gear connection part 63 is assembled into the first driving gear 51 of the power transmission member 50 on one side of the first support 14a in such a way as to be rotatable. Accordingly, the rotary motion of the waterwheel 60 can be transferred to the first driving gear 51 of the power transmission member 50, the first driven gear 52 engaged with the first driving gear 51, the first driven shaft 53, and the second driving gear 55 at the same time through the driving gear connection part 63.

Next, the second driving gear 55 of the power transmission member 50 and the second driven gear 73 of the power generation member 70 are engaged, and the waterwheel fixing block 14e is assembled into the lower part of the vertical structure 12. In this case, the waterwheel fixing block 14e supports each of the waterwheel 60 to have the waterwheel 60 immersed underwater so that the waterwheel 60 is freely rotated in response to the amount of water and a flow rate around a pier pillar. The waterwheel fixing block 14e is assembled at the lower part of the vertical structure 12 through separate assembly means, thereby completing the installation. Accordingly, the power transmission member 50 and the power generation member 70 transfer the rotatory power of the waterwheel to the second driven shaft 71 by the second driven gear 73 of the power generation member 70 engaged with the second driving gear 55, thereby being capable of generating electrical energy through the generator G disposed at the upper end of the vertical structure 12 so that it is not immersed in water.

Accordingly, the present invention enables small hydraulic power generation relatively simply using the existing structure even without installing a new structure for the small hydraulic power generation. Accordingly, the freely controlled power generation apparatus 100 of the present invention has an advantage in that it can improve its utilization using the existing structure, such as a bridge or a pier, for multiple purposes. Furthermore, the freely controlled power generation apparatus 100 can have an advantage in that it can reduce an economic cost according to the development and production of renewable energy because it enables small hydraulic power generation at a lower cost.

### Detailed Description of the Embodiments

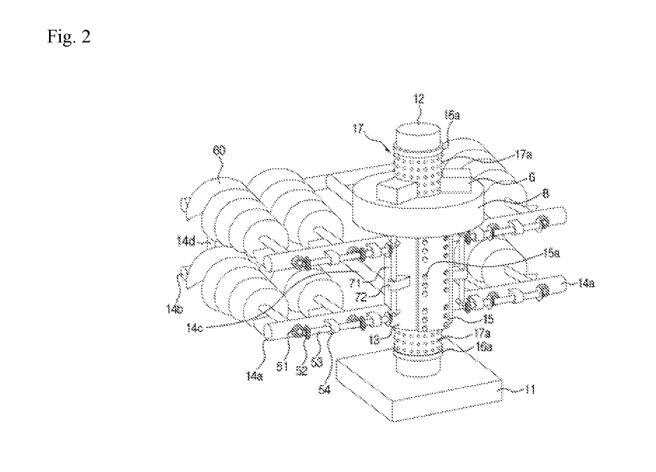

FIG. 2 is a schematic perspective view of the second exemplary embodiment of the freely controlled power generation apparatus 100 according to the present invention. In FIG. 2, the freely controlled power generation apparatus 100 according to the present invention may be installed on the vertical structure 12 of the floor structure 11 as described above, and may include the support 14, the power transmission member 50, the waterwheel 60, and the power generation member 70 as in the first embodiment. Unlike in the first exemplary embodiment, however, the freely controlled power generation apparatus 100 may includes a cylindrical body 13 in such a way as to elevate and rotate on the vertical structure 12 up and down instead of the waterwheel fixing block 14e of the first exemplary embodiment, and may includes a bearing assembly and a buoyant body.

Specifically, the freely controlled power generation apparatus 100 is configured to may includes a vertical structure 12 immersed in water; a cylindrical body 13 disposed on the outer circumferential surface of the vertical structure 12 in such a way as to elevate and rotate; a buoyant body B fixed with respect to the cylindrical body 13 and providing buoyancy; a support 14 extended from the cylindrical body 13; a waterwheel of a screw (S) shape rotatably supported by the support 14; a power transmission member 50 transferring the rotatory power of the waterwheel of a screw (S) shape; and a power generation member 70 may includes a generator G that generates electrical power by electric power transferred through the power transmission member 50.

The vertical structure 12 is constructed at the location in which the flow of water is present, such as a sea or river. The vertical structure 12 is extended from a floor structure 11, fixed to the ocean floor or the bottom of a river, to the surface of the water. As described above, a detailed type or kind is not related to the range of right if the vertical structure is disposed at the location in which the flow of water is present, such as a sea or river.

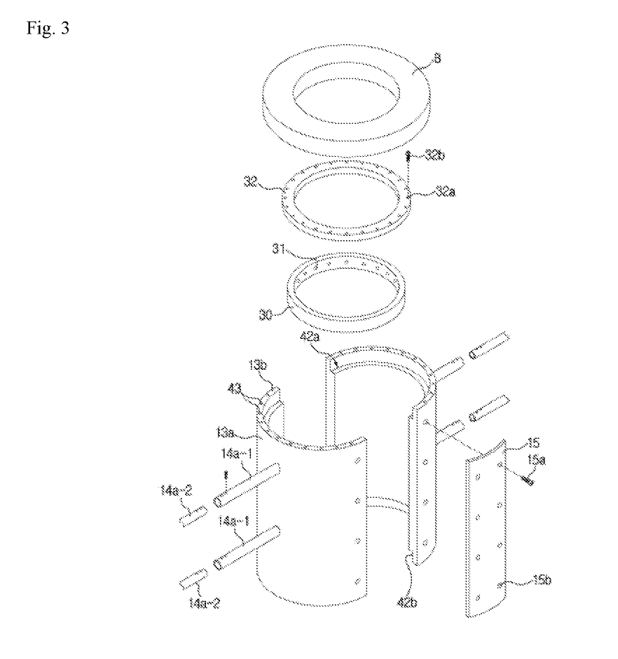

The cylindrical body 13 according to the second exemplary embodiment may elevate along the vertical structure 12 and may also rotate around the vertical structure 12. The cylindrical body 13 may have two half cylindrical portions interconnected by a connection plate 15 (this may be understood by the connection structure of half cylindrical portions 13a and 13b shown in FIG. 3. That is, bolts 15a formed in the connection plate 15 are inserted through through holes 15b and fixed to the half cylindrical portions 13a and 13b, and thus the two half cylindrical portions may form the cylindrical body 13). Although FIG. 2 shows only one connection plate 15, it may be understood that another connection plate 15 is disposed on the opposite side in the direction of the diameter of the connection plate 15 and connects the half cylindrical portions 13a and 13b.

A bearing assembly 17 may includes a cylindrical bearing plate installed on the external surface of the vertical structure 12 and surrounding the vertical structure 12 and a plurality of balls 17a installed on the cylindrical bearing plate. The plurality of balls 17a is installed to roll on their positions without a change in their positions on the cylindrical bearing plate.

Only part of the surface of the ball 17a is exposed to the outside of the surface of the bearing plate, whereas most of the surface of the ball is buried in the bearing plate. When the ball 17a rotates, a subject that has come into contact with the exposed surface of the ball 17a can move without friction. Since only part of the sphere of the ball 17a is exposed to the outside of the surface of the bearing plate, the ball 17a can roll on its position without being detached or separated from the bearing plate.

The cylindrical body 13 is disposed to surround the bearing assembly 17 and supported by the ball 17a, so the cylindrical body 13 can be subjected to an elevation and rotary motion by the bearing assembly 17. The cylindrical body 13 can elevate and rotate without friction because the plurality of balls 17a is disposed between the inner surface of the cylindrical body 13 and the bearing plate of the bearing assembly 17.

The buoyant body B is provided at the upper end of the cylindrical body 13. The buoyant body B functions to buoy the cylindrical body 13 and all of other structures connected to the cylindrical body 13.

The cylindrical body 13 can be maintained in a proper depth underwater by the buoyancy of the buoyant body B. The size and shape of the buoyant body may be fabricated in accordance with the size of a structure and a field condition.

An upper hitch jaw 16a for limiting the rise of the cylindrical body 13 and a lower hitch jaw 16b for limit the fall of the cylindrical body 13 are disposed on the vertical structure 12 at the upper and lower ends of the bearing assembly 17, respectively. The upper hitch jaw 16a and the lower hitch jaw 16b may be configured in the form of a ring that surrounds the vertical structure, for example. The upper and lower ends of the cylindrical body 13 may be caught in the upper hitch jaw 16a and the lower hitch jaw 16b. Accordingly, the breakaway of the power generation body can be prevented, and the loss of the power generation body can be prevented because the power generation body does not come into contact with the bottom surface.

A support 14 (a first support 14a, a second support 14b, a third support 14c, and a fourth support 14d) is extended from the surface of the cylindrical body 13. The waterwheel 60 of a screw (S) shape are rotatably supported by the supports 14a, 14a ′, 14b and 14c. In the example shown in the drawing, the first support 14a are extended from the surface of the cylindrical body 13 in a straight line in such a way as to face each other. The third support 14c is extended from a surface of the connection plate 15 at a right angle to the first support 14a (that is, extended from a surface of another connection plate 15 disposed on the opposite side of the connection plate 15 disposed at the front of FIG. 2). The second support 14b are extended in parallel to the first support 14a in the state in which they have been supported by the third support 14c. In the example shown in the drawing, it may be understood that the first to third supports may be disposed at different heights of the cylindrical body 13. Meanwhile, the fourth support 14d may be provided to connect a pair of the second support 14b disposed up and down.

A rotating shaft 61 at both ends of the screw S is rotatably disposed in the first support 14a and the second support 14b. The screw S has a shape capable of being rotated by the flow of water. The rotating shaft 61 of the screw S extends though the first support 14a. The first driving gear 51 formed of a bevel gear is fixed to the rotating shaft of the screw S that extends through the first support 14a.

Meanwhile, as described in the first exemplary embodiment, the power transmission member 50 that transfers the rotatory power of the screw S may include the first driven shaft 53 extending in parallel to the first support 14a. The power generation member 70 may include the generator G and a second driven shaft 71 extending through a buoyant body B vertically along the cylindrical body 13. The first driven shaft 53 is fixed to the first support 14a and rotatably supported by the first driven shaft fixture 54 having bearings therein. The second driven shaft 71 is fixed to the cylindrical body 13 and rotatably supported by a second driven shaft fixture 72 having bearings therein.

The first driving gear 51 installed on the rotating shaft 61 of the screw S is engaged with the first driven gear 52 disposed in the first driven shaft 53. Furthermore, a second driving gear 55 disposed at one end of the first driven shaft 53 and a second driven gear 73 disposed at one end of the second driven shaft 71 are engaged. Accordingly, the rotatory power of the screw S can be transferred through the first driven shaft 53 and the second driven shaft 71.

The second driven shaft 71 is extended through the buoyant body B and connected to the generator G, thus driving the generator G. The connection between the second driven shaft 71 and the rotor of the generator G is the same as that of the aforementioned first exemplary embodiment.

In another example not shown in the drawings, the generator G may be disposed within the buoyant body B. Furthermore, it is to be understood that the first driven shaft 53, the second driven shaft 71, the bearings and the gears may be designed to be surrounded by sealing structures.

As the screw S is rotated by the flow of water, the generator G configured as described above can be driven to generate electrical power. That is, when the screw S is rotated by the flow of water, the first driven shaft 53 and the second driven shaft 71 for electrical power transmission which are engaged by the gears transfer rotatory power, so the rotor of the generator G can be driven to generate electrical power.

Meanwhile, when the depth of water changes or the direction of the flow of water changes, the cylindrical body 13 may elevate or rotate to the location where the rotation of the screw S has been optimized. For example, when the depth of water changes, the cylindrical body 13 elevates by the buoyancy of the buoyant body B. At this time, the elevation height may be restricted by the upper hitch jaw 16a and the lower hitch jaw 16b. Furthermore, when the direction of the flow of water changes, the cylindrical body 13 rotates around the circumstance of the vertical structure 12, so the location of the screw S can be changed.

FIG. 3 is a schematic exploded partial-perspective view of the third exemplary embodiment of the freely controlled power generation apparatus according to the present invention. Elements that belong to the elements shown in FIG. 3 and that are the same as the elements of FIG. 2 are assigned the same drawing numerals as those of FIG. 2.

As shown in FIG. 3, two half cylindrical portions 13a and 13b may be connected by the connection plate 15. In the example shown in the drawing, it may be understood that only one connection plate 15 has been illustrated, but the other connection plate is further provided at the opposite location. The connection plate 15 may interconnect the first and the second half cylindrical portions 13a and 13b using bolt 15a fixed to the half cylindrical portions 13a and 13b through through hole 15b.

In the third exemplary embodiment shown in FIG. 3, the cylindrical body 13 may elevate and rotate around the circumference of the cylindrical plate (not shown) that surrounds the vertical structure 12 and that has a smooth surface using an upper bearing assembly 30 and a lower bearing assembly (not shown) respectively disposed at the upper and lower portions of the cylindrical body instead of the bearing assembly 17 according to the second exemplary embodiment shown in FIG. 2. As shown in the drawing, the upper bearing assembly 30 may include the plurality of balls 17a installed on the inner circumferential surface thereof. Part of the surface of the sphere of the ball 17a is exposed to the inner circumferential surface, and thus the ball 17a can roll on the inner circumferential surface without being broken away or separated there from.

The upper bearing assembly 30 is disposed in an upper bearing seating unit 42a formed in a step shape at the upper portions of the first and the second half cylindrical portions 13a and 13b. An upper annular plate 32 is fixed to the upper end of the first and the second half cylindrical portions 13a and 13b, so the upper bearing assembly 30 is installed. That is, bolt 32b are inserted through the hole 32a of the upper annular plate 32 and coupled to the screw hole 43 of the first and the second half cylindrical portions 13a and 13b, so the upper bearing assembly 30 is fixed.

A lower bearing assembly not shown in the drawing is disposed in a lower bearing seating unit 42b and may be fixed using a lower annular plate (not shown) in the same manner as that described above.

The ball 17a provided in the upper bearing assembly 30 and the lower bearing assembly (not shown) can roll on a cylindrical plate that surrounds the vertical structure 12 as in the second exemplary embodiment shown in FIG. 2. That is, instead of the bearing assembly 17 according to the second exemplary embodiment shown in FIG. 2, the cylindrical plate (not shown) having a smooth surface is disposed to surround the vertical structure 12 and the first and the second half cylindrical portions 13a and 13b are disposed to surround the cylindrical plate (not shown). In this case, when the cylindrical body formed of the half cylindrical portions 13a and 13b performs an up-and-down or rotary motion, the upper bearing assembly 30 and the lower bearing assembly (not shown) may roll on a surface of the cylindrical plate (not shown).

In the third exemplary embodiment, it is to be understood that if the cylindrical plate (not shown) surrounding the vertical structure 12 is removed, the up-and-down or rotary motion of the cylindrical body may be performed because the ball 17a roll on a surface of the vertical structure 12. Furthermore, it is to be understood that the hitch jaws 16a and 16b shown in FIG. 2 may also be provided in the example shown in FIG. 3.

The first support 14a is extended from the first and the second half cylindrical portions 13a and 13b. The first support 14a may include a fixing support 14a-1 and an insertion support 14a-2. The insertion support 14a-2 is inserted through the hollow portion of the fixing support 14a-1, so the insertion support 14a-2 and the fixing support 14a-1 are interconnected.

In this case, the length of the support may be adjusted by adjusting the length of the insertion support 14a-2 inserted into the hollow portion of the fixing support 14a-1. The fixing support 14a-1 and the insertion support 14a-2 may be mutually fixed by matching a hole formed in the circumferential surface or side of the fixing support 14a-1 and a hole formed in the circumferential surface or side of the insertion support 14a-2 and inserting a key into the matched hole.

Although not shown in the drawings, it may be understood that the screw S may be rotatably supported by a structure including the fixing support and the insertion support as shown in FIG. 2 and a power transmission member including the first driven shaft 53 and the second driven shaft 71 may be installed. In the example shown in FIG. 3, the rotation of the screw S is optimized as the cylindrical body is elevated or rotated by the upper bearing assembly 30 and the lower bearing assembly (not shown), and thus power generation can be efficiently performed.

Meanwhile, it is to be understood that the structure including the fixing support 14a-1 and the insertion support 14a-2 shown in FIG. 3 may substitute the first to fourth supports 14a, 14b, 14c and 14d shown in FIG. 2. That is, the length of the support can be varied and increased by configuring some or all of the supports as the fixing support and the insertion support. This modulates the support and enables the support to be easily installed and an increase of the number of screws S to be handled.

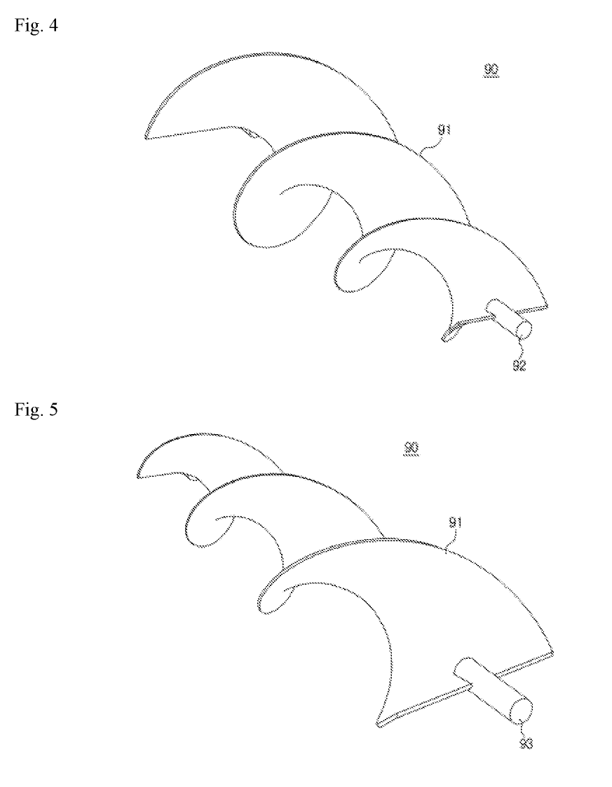

In addition, the waterwheel of a screw shape provided in the freely controlled power generation apparatus 100 according to the aforementioned first, second and third exemplary embodiment may be configured in the form of a non-shaft screw. FIGS. 4 and 5 are schematic perspective views of examples of a non-shaft screw which may be applied to the freely controlled power generation apparatus according to the present invention.

As shown in FIGS. 4 and 5, the non-shaft screw 90 may include a rotary blade 91 formed in a screw shape in the state in which a central shaft is not present and a first unit 92, a second support unit 93, extended to correspond to the center of rotation of the rotary blade 191 and fixed to the first end and second end of the rotary blade 91 to rotatably support the rotary blade 91. A general shape of the non-shaft screw 90 according to the present invention is a taper shape in which the rotary blade 91 has a small diameter at the first end in the length direction, whereas the rotary blade 91 has a large diameter at the second end. That is, when the non-shaft screw 90 is viewed from a cross section that is a right angle to the first support unit 92 or the second support unit 93, the diameter of the rotary blade 91 is a small diameter at the first end to which the first support unit 92 has been fixed, but is a large diameter at the second end to which the second support unit 93 has been fixed. When the non-shaft screw 90 is installed on the support 14, it is preferred that the first end having a small diameter is installed toward the upstream side. This is for allowing pressure applied when a fluid moves to be applied to the entire rotary blade 91 of the non-shaft screw 90. Furthermore, the non-shaft screw 90 may includes the first support unit 92 or second support unit 93 at both ends thereof instead of the rotating shaft, thereby reducing the weight of the non-shaft screw 90 itself. Accordingly, the non-shaft screw 90 can be further rotated by pressure of water and a force applied to the support 14 can be minimized.

As described above, a general shape of the non-shaft screw 90 according to the present invention is a taper shape in which the rotary blade 91 has a small diameter at the first end in the length direction, whereas the rotary blade 91 has a large diameter at the second end.

FIG. 4 shows the first support unit 92 fixed to the rotary blade 91 at the first end having a small diameter, whereas FIG. 5 shows the second support unit 93 fixed to the rotary blade 91 at the second end having a large diameter. Each of the first support unit 92 and the second support unit 93 is fixed to the rotary blade 92 by proper means in the state in which the support unit has been disposed to be matched with the center of rotation of the rotary blade 91. As described above, each of the first support unit 92 and the second support unit 93 is rotatably installed on the support 14 and extended through the first support 14a. The first driving gear 51 is disposed at the end of the support unit 92 or 93.

As shown in the drawing, it may be understood that the rotary blade 91 of the non-shaft screw 90 is a sheet-shaped member configured to have a specific thickness and a gradually increasing width and to have a screw shape. Since the width of the sheet-shaped member gradually increases in the length direction, the diameter of the rotary blade 91 of the non-shaft screw is the smallest at the first end to which the first support unit 92 is fixed and the diameter of the rotary blade 91 is the largest at the second end to which the second support unit 93 is fixed. If the non-shaft screw 12 is disposed in a river or waterway, the first support unit 92 fixed to the first end having a small diameter is disposed toward the upstream. The rotary blade 91 is formed in the non-shaft screw 90 so that the first support unit 92 or second support 93 is rotated around the rotating shaft by pressure applied to a surface of the rotary blade 91 due to a flow of a fluid inflowing from the upstream.

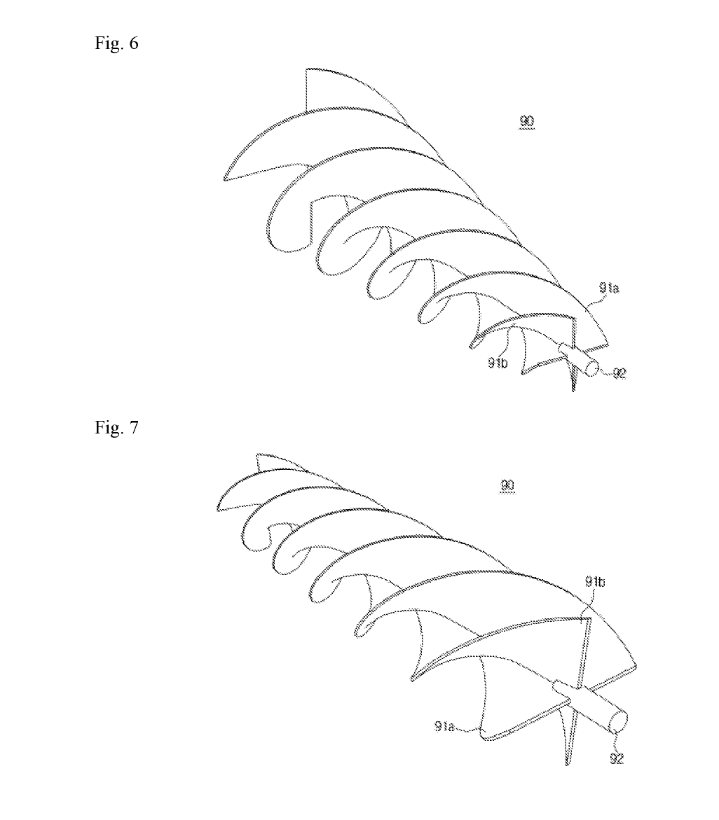

FIGS. 6 and 7 are schematic perspective views of other examples of the non-shaft screw.

Referring to FIG. 6, the non-shaft screw 90 includes rotary blades 91a and 91b, a first support unit 92 fixed to a first end having a small diameter, and a second support unit (not shown in FIG. 6) fixed to a second end having a large diameter. It may be understood that the non-shaft screw 32 shown in FIG. 6 has two sheet-shaped members configured to have the same screw shape in the state in which the two sheet-shaped members each having a constant thickness and a width increasing along the length have been disposed at a right angle to each other at one end. That is, one sheet-shaped member is formed of the first rotary blade 9a, and the other sheet-shaped member is formed of the second rotary blade 91b. When viewed from a cross section at a right angle to the first support unit 92 disposed as the rotating shaft of the non-shaft screw 90, the diameter of the non-shaft screw 90 gradually increases from the first end to which the first support unit 92 has been fixed to the second end to which the second support unit (not shown in FIG. 6) has been fixed on the opposite side.

Referring to FIG. 7, the non-shaft screw 90 may includes a rotary blades 91a and 91b, a first support unit 92 fixed to a first end, and a second support unit (not shown in FIG. 7) fixed to a second end. Unlike in the embodiment shown in FIG. 6, the diameter of the non-shaft screw 90 is the same at the first end and the second end. It may be understood that the non-shaft screw 90 shown in FIG. 7 has two sheet-shaped members configured to have the same screw shape in the state in which the two sheet-shaped members having a constant thickness and a constant width along the length have been disposed at a right angle to each other at one end. That is, one sheet-shaped member is formed of the first rotary blade 9a, and the other sheet-shaped member is formed of the second rotary blade 91b. When viewed from a cross section that is a right angle to the first support unit 92 disposed as the rotating shaft of the non-shaft screw 90, the diameter of the non-shaft screw 90 is constant from the first end to which the first support unit 92 has been fixed to the second end to which the second support unit (not shown in FIG. 7) has been fixed on the opposite side.

The aforementioned non-shaft screw power generation apparatus is installed in a deep river or sea in which the flow rate of water is generated. A plurality of the non-shaft screws are installed vertically and/or horizontally depending on the depth and width of water in which the flow rate is generated, and the size and number of non-shaft screws are determined depending on the amount of power generated.

In addition, the configuration and method of the aforementioned exemplary embodiments are not limited and applied to the apparatus and method as described above, but some or all of the exemplary embodiments may be selectively combined and configured so that the exemplary embodiments are modified in various ways.

1. A freely controlled power generation apparatus, comprising:
a support assembled and disposed on an outer circumferential surface of a vertical structure by a waterwheel fixing block, having first supports integrally extended and installed on the support horizontally based on the waterwheel fixing block on both left and right sides thereof, and supporting and fixing at least one waterwheel to be spaced apart at a specific interval by the first supports and second supports having at least one auxiliary support corresponding to the first supports formed therein, wherein the support supports and fixes the waterwheels to be immersed under a surface of water so that the waterwheels are freely rotatable depending on an amount of water and a flow rate around the vertical structure;
at least one waterwheel having a waterwheel blade of a screw shape formed on an external surface of a rotating shaft of a rod shape, wherein both ends of the rotating shaft are supported by the support in such a way as to be freely rotatable, and performing a rotational motion on the rotating shaft by rotatory power of the waterwheel blade attributable to a flow of water; and
a power generation member connected through a power transmission member comprising a plurality of gears connected to one end of the rotating shaft and generating electrical energy by a rotational motion of the rotating shaft,
wherein the freely controlled power generation apparatus further comprises a waterwheel movement guide member comprising a guide block having one end assembled and fixed to the waterwheel fixing block in parallel to the waterwheel and the other end formed to be movable up and down and left and right as a free end, wherein a body of the free end is extended and installed up and down and an up/down guide groove into which the second support is able to be fit and assembled is formed at the extended and installed end, and the waterwheel movement guide member limitedly guides and supports an up/down movement and left/right movement of the waterwheel according to the amount of water and the flow rate within a specific range.

2. The freely controlled power generation apparatus of claim 1, wherein the second support has a left/right guide rod fit and assembled into the up/down guide groove of the guide block and integrally provided at a central part, hitch jaws for limiting a left/right movement within a specific range being formed on both sides of the left/right guide rod.

3. The freely controlled power generation apparatus of claim 1, wherein:
the support is arranged in two columns or more in parallel up and down and assembled and disposed on the outer circumferential surface of the vertical structure by each waterwheel fixing block, and
at least one waterwheel is installed on each of the supports.

4. A freely controlled power generation apparatus, comprising:
a vertical structure immersed in water;
a cylindrical body disposed on an outer circumferential surface of the vertical structure in such a way as to elevate and rotate;
a buoyant body fixed with respect to the cylindrical body and providing buoyancy;
a plurality of support extended from the cylindrical body;
at least one waterwheel having a waterwheel blade of a screw shape formed on an external surface of a rotating shaft of a rod shape, wherein both ends of the rotating shaft are supported by the support in such a way as to be freely rotatable, and performing a rotational motion on a waterwheel shaft by rotatory power of the waterwheel blade attributable to a flow of water;
a power transmission member transferring the rotatory power of the waterwheel;
a power generation member generating electricity by electric power transferred through the power transmission member; and
a bearing assembly comprising a bearing plate surrounding the vertical structure and a plurality of balls rotatably buried in the bearing plate,
wherein the bearing assembly is disposed between an outer surface of the vertical structure and an inner surface of the cylindrical body.

5. The freely controlled power generation apparatus of claim 4, wherein an upper hitch jaw and a lower hitch jaw are further provided in the vertical structure in order to restrict an elevation of the cylindrical body.

6. The freely controlled power generation apparatus of claim 4, further comprising a bearing assembly comprising an annular plate and a plurality of balls rotatably buried in an inner circumferential surface of the annular plate, wherein the bearing assembly is disposed at each of upper and lower parts of the cylindrical body.

7. The freely controlled power generation apparatus of claim 4, wherein:
the cylindrical body comprises a first half cylindrical portion and a second half cylindrical portion, and
the first half cylindrical portion and the second half cylindrical portion are interconnected by a connection plate.

8. The freely controlled power generation apparatus of claim 4, wherein the power transmission member comprises:
a first driven shaft extended in parallel to the support supporting the rotating shaft of the waterwheel;
a second driven shaft extended in parallel to the vertical structure; and
gears disposed in the rotating shaft of the waterwheel, the first driven shaft and the second driven shaft and engaged with each other.

9. The freely controlled power generation apparatus of claim 4, wherein at least any one of the supports extended from the cylindrical body comprises a fixing support and an insertion support capable of being inserted into a hollow portion of the fixing support.

10. The freely controlled power generation apparatus of claim 4, wherein:
the waterwheel comprises a non-shaft screw, and
the non-shaft screw comprises a rotary blade of a screw shape and a first support unit and second support unit respectively extended from a first end and second end in accordance with a center of rotation of the non-shaft screw.

11. The freely controlled power generation apparatus of claim 10, wherein:
a sheet-shaped member having a specific thickness and a gradually increasing width in the rotary blade of the non-shaft screw is configured to have a screw shape, and
a diameter of the rotary blade increases from the first support unit to the second support unit.

12. The freely controlled power generation apparatus of claim 10, wherein:
each of two sheet-shaped members having a specific thickness and a gradually increasing width in the rotary blade of the non-shaft screw is configured to have a screw shape in a state in which the two sheet-shaped members have been disposed at a right angle to each other at one end, and
a diameter of the rotary blade increases from the first support unit to the second support unit.

13. The freely controlled power generation apparatus of claim 10, wherein:
a diameter of the rotary blade at the first end of the non-shaft screw is smaller than a diameter of the rotary blade at the second end, and
the first end of the non-shaft screw faces an upstream side of a flow of a fluid.

14. The freely controlled power generation apparatus of claim 10, wherein:
each of two sheet-shaped members having a specific thickness in the rotary blade of the non-shaft screw is configured to have a screw shape in a state in which the two sheet-shaped members have been disposed at a right angle to each other at one end, and
a diameter of the rotary blade is identical in the first support unit and the second support unit.
